(19) United States
(12) Patent Application Publication
(10) Pub. No.: US 2025/0286762 A1
(43) Pub. Date: Sep. 11, 2025

(54) SRS ENHANCEMENT TO SUPPORT MORE THAN 4 LAYER NON-CODEBOOK BASED UPLINK TRANSMISSION

(71) Applicant: APPLE INC., Cupertino, CA (US)

(72) Inventors: Haitong Sun, Cupertino, CA (US); Wei Zeng, San Diego, CA (US); Dawei Zhang, Saratoga, CA (US); Chunxuan Ye, San Diego, CA (US); Yushu Zhang, Beijing (CN); Oghenekome Oteri, San Diego, CA (US); Seyed Ali Akbar Fakoorian, San Diego, CA (US); Sigen Ye, San Diego, CA (US)

(21) Appl. No.: 18/858,939

(22) PCT Filed: Apr. 28, 2022
(86) PCT No.: PCT/CN2022/089799

§ 371 Date: Oct. 22, 2024

(51) Int. Cl. H04L 27/26; H04B 7/06; H04W 72/232

(52) U.S. Cl. CPC H04L 27/261; H04B 7/0626; H04W 72/232

(57) ABSTRACT

The present disclosure relates to SRS enhancement to support more than four layers non-codebook based uplink transmission. In an aspect, a wireless device may comprise at least one antenna; at least one radio coupled to the at least one antenna; and a processor coupled to the at least one radio; wherein the processor is configured to: receive, via the at least one radio, at least one Radio Resource Control (RRC) signaling from a cellular base station, wherein, the at least one RRC signaling configures at least one group of N Sounding Reference Signal (SRS) resources for non-codebook, N>4, and each SRS resource is configured with one port; and transmit, via the at least one radio, SRSs to the cellular base station on the configured group of SRS resources, wherein each SRS is transmitted on one SRS resource of the configured group of SRS resources.

### TECHNICAL FIELD

This application relates generally to wireless communication systems, including wireless device, cellular base station, methods, apparatus for Sounding Reference Signal (SRS) enhancement to support more than 4 layer non-codebook based uplink transmission.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### SUMMARY

Embodiments relate to device, method, apparatus, computer-readable storage medium and computer program product for wireless communication.

According to an aspect, there is provided a wireless device, comprising: at least one antenna; at least one radio coupled to the at least one antenna; and a processor coupled to the at least one radio; wherein the processor is configured to: receive, via the at least one radio, at least one Radio Resource Control (RRC) signaling from a cellular base station, wherein, the at least one RRC signaling configures at least one group of N Sounding Reference Signal (SRS) resources for non-codebook, N>4, and each SRS resource is configured with one port; and transmit, via the at least one radio, SRSs to the cellular base station on the configured group of SRS resources, wherein each SRS is transmitted on one SRS resource of the configured group of SRS resources.

According to another aspect, there is provided a cellular base station, comprising: at least one antenna; at least one radio coupled to the at least one antenna; and a processor coupled to the at least one radio; wherein the processor is configured to: transmit, via the at least one radio, at least one Radio Resource Control (RRC) signaling to a wireless device, wherein, the at least one RRC signaling configures at least one group of N Sounding Reference Signal (SRS) resources for non-codebook, N>4, and each SRS resource is configured with one port; and receive, via the at least one radio, SRSs from the wireless device on the configured group of SRS resources, wherein each SRS is received on one SRS resource of the configured group of SRS resources.

According to another aspect, there is provided a method for a wireless device, comprising: receiving at least one Radio Resource Control (RRC) signaling from a cellular base station, wherein, the at least one RRC signaling configures at least one group of N Sounding Reference Signal (SRS) resources for non-codebook, N>4, and each SRS resource is configured with one port; and transmitting SRSs to the cellular base station on the configured group of SRS resources, wherein each SRS is transmitted on one SRS resource of the configured group of SRS resources.

According to another aspect, there is provided a method for a cellular base station, comprising transmitting at least one Radio Resource Control (RRC) signaling to a wireless device, wherein, the at least one RRC signaling configures at least one group of N Sounding Reference Signal (SRS) resources for non-codebook, N>4, and each SRS resource is configured with one port; and receiving SRSs from the wireless device on the configured group of SRS resources, wherein each SRS is received on one SRS resource of the configured group of SRS resources.

According to another aspect, there is provided an apparatus, comprising: a processor configured to cause a wireless device to: receive, via the at least one radio, at least one Radio Resource Control (RRC) signaling from a cellular base station, wherein, the at least one RRC signaling configures at least one group of N Sounding Reference Signal (SRS) resources for non-codebook, N>4, and each SRS resource is configured with one port; and transmit, via the at least one radio, SRSs to the cellular base station on the configured group of SRS resources, wherein each SRS is transmitted on one SRS resource of the configured group of SRS resources.

According to another aspect, there is provided computer-readable storage medium storing program instructions, wherein the program instructions, when executed by a computer system, cause the computer system to perform the method of any of the above aspects.

According to another aspect, there is provided a computer program product, comprising program instructions which, when executed by a computer, cause the computer to perform the method of any of the above aspects.

The techniques described herein may be implemented in and/or used with a number of different types of devices, including but not limited to cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates a general flow-chat according to the present disclosure.

FIG. 4A illustrates an example of SRS resource configuration in which each SRS resource occupies a separate symbol.

FIG. 4B illustrates an example of non-codebook SRS resource configuration in which two SRS resources occupy a same symbol.

FIG. 5 illustrates an example of non-codebook SRS resource configuration for aperiodic SRS transmission.

FIG. 6A illustrates an example assignment of identifiers for SRS resource sets and SRS resources.

FIG. 6B illustrates an example of identifiers of SRS resources corresponding to a general order based on the identifiers of the SRS resource sets.

FIG. 7 illustrates an example of non-codebook SRS resource configuration for aperiodic SRS transmission for the scenario enabling two-TRP operation.

FIG. 8A illustrates an example of non-codebook SRS resource configuration enabling the UE to determine mapping between an SRI/QCL/Spatial relation and a specific SRS resource set.

FIG. 8B illustrates another example of non-codebook SRS resource configuration enabling the UE to determine mapping between an SRI/QCL/Spatial relation and a specific SRS resource set.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

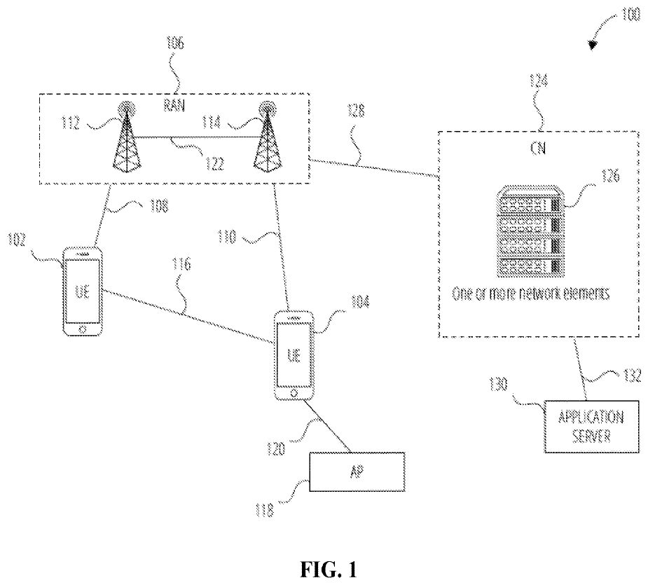

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VOIP sessions, group communication sessions, etc.) for the UE 102 and UE 104 via the CN 124. The application server 130 may communicate with the CN 124 through an IP communications interface 132.

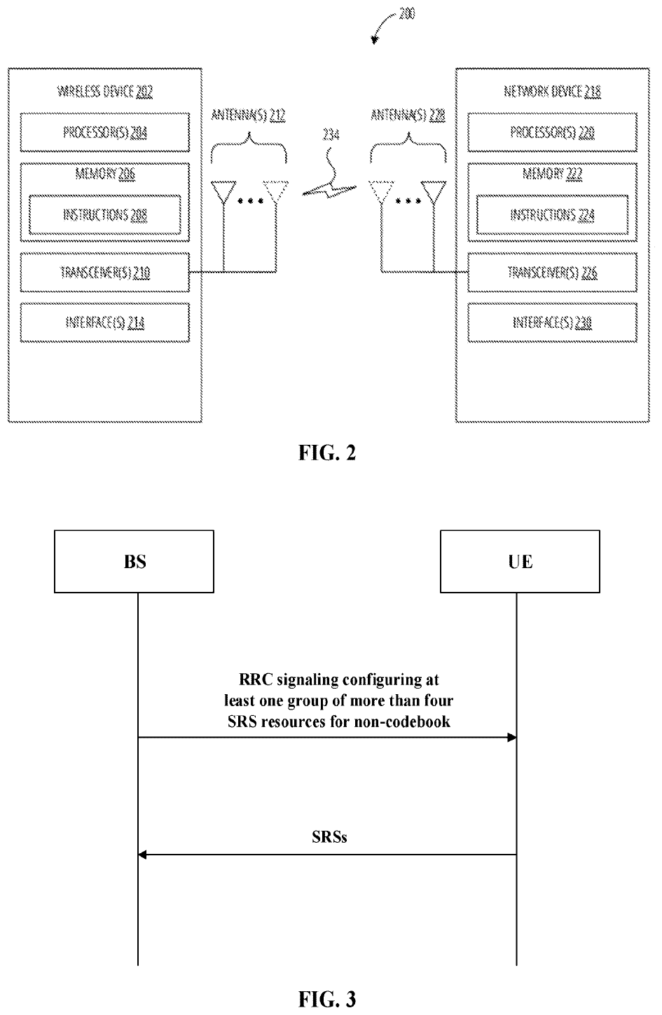

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

The following description will take 5G NR as an example to illustrate the concept of the present disclosure, but it should be understood that the solution of the present disclosure is applicable to any appropriate mobile communication technology (e.g. 6G or any applicable advanced mobile communication technology).

In the following description, gNB is sometimes used to represent the control device at the base station side in a wireless communication network. It should be understood this is for illustrative purpose only but not restrictive. A base station based on any appropriate mobile communication technology is applicable.

In 5G NR, there are roughly three different types of uplink (UL) transmission scheme: not-configured, codebook based and non-codebook based. Under the context of the present disclosure, codebook may refer to a set of precoders (i.e. a set of precoding matrix). The present disclosure mainly refers to the non-codebook based UL transmission. Hereinafter, for simplicity, UL transmission refers to the non-codebook based UL transmission unless otherwise explicitly defined. In non-codebook based transmission, the UE would estimate UL channel(s) according to the received Channel Status Information Reference Signal (CSI-RS) based on the assumptions of channel reciprocity, and determine precoding information (e.g. create the precoding matrix(es)) for uplink transmission at the UE side. In other words, under non-codebook based transmission, the UE would calculate precoder(s) for uplink transmission based on the received CSI-RS(s) at the UE side.

As the development of the wireless devices, the capability of the wireless devices in uplink transmission is improving. For example, as the development of capabilities regarding computation and communication of wireless devices, a UE is going to support to simultaneously transmit more data streams to the base station with each data stream being precoded using a respective precoder, especially for non-codebook based uplink transmission. The simultaneously transmitted number of data streams can correspond to the number of layers.

Although current communication mechanism supports multi-layer non-codebook based uplink transmission, the number of layers supported is too small to satisfy the requirement of uplink data rate increasement.

Therefore, there is a need to provide a solution to support more layers, preferably more than 4 layers for non-codebook based uplink transmission so as to increase the uplink data rate.

In general, to support multi-layer non-codebook based uplink transmission, a UE will firstly transmit, to a gNB, multiple SRSs on multiple SRS resources configured by the gNB, wherein each SRS is transmitted on a respective SRS resource using a respective precoder. Upon receiving the SRSs, the gNB will select at least one of the SRSs according to for example, the signal reception quality, and indicate the selected SRS(s) (i.e. the corresponding SRS resource(s)) by transmitting Downlink Control Information (DCI) to the UE so as to indicate the UE to use the same precoder(s) for uplink data with that used for transmitting the selected SRS(s). After being indicated by the gNB, the UE can simultaneously transmit uplink data using the selected precoders respectively.

Therefore, in order to support more layers, preferably more than 4 layers for non-codebook based uplink transmission, it is required for the gNB to configure more than 4 SRS resources for non-codebook for transmitting SRSs. For simplicity, the SRS resource recited herein refers to SRS resource for non-codebook unless otherwise explicitly defined.

FIG. 3 is a general flow-chat according to the present disclosure.

As illustrated in FIG. 3, according to the present disclosure, the base station (herein after BS) can provide at least one RRC signaling to a wireless device (herein after UE). The at least one RRC signaling can configure at least one group of SRS resources for non-codebook, each group comprising N SRS resources, N>4 and being an integer, and each SRS resource is configured with one port (e.g. one channel, in terms of a combination of time resource, frequency resource and orthogonal code).

As known in the art, SRS can be transmitted periodically, aperiodically (i.e. triggered by DCI), or semi-persistently (i.e. periodically transmitted during an active window). Practically, for example, the BS may configure three groups of SRS resources for non-codebook for periodic SRS transmission, semi-persistent SRS transmission and aperiodic SRS transmission respectively. For example, each group can comprise a same number of SRS resources, e.g. more than four SRS transmission resources. Alternatively, each group does not necessarily comprise a same number of SRS resources. For example, any of the groups of SRS resources configured for periodic/semi-persistent/aperiodic SRS transmission can comprise more than four SRS resources, while any of the rest groups of SRS resources can comprise less than four SRS resources.

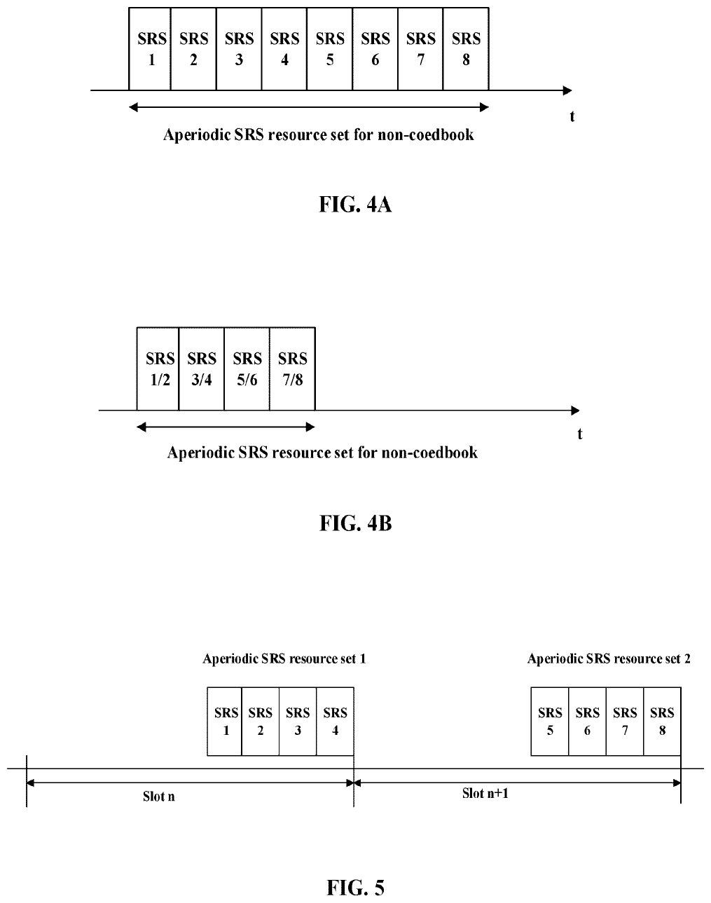

According to the present disclosure, the UE can transmit SRSs to the base station on the configured group of SRS resources, wherein each SRS is transmitted on one SRS of the configured group of SRS resources. At one time, the UE can transmit SRSs on all the SRS resources configured in one group using a different precoder for each SRS, such that a relatively large number of SRSs can be sounded at the BS side which enables the BS to select more precoders for the UE to transmit uplink data streams simultaneously. For example, as shown in FIG. 4A and FIG. 4B (note that the SRSs 1-8 shown in FIG. 4A and FIG. 4B actually refer to SRS resources 1-8 for simplicity), a group of 8 SRS resources can be configured. In this case, the UE can transmit 8 SRSs on all the 8 SRS resources configured in the group using a different precoder for each SRS. Therefore, the BS can select at most 8 SRSs. In turn, the UE can transmit up to 8 data streams simultaneously. In other words, up to 8 layers non-codebook based UL transmission can be supported.

According to the present disclosure, the number of SRS resources contained in a group can be determined based on the capability of UE. For example, the number of SRS resources contained in a group can correspond to the maximum number of layers supported by the UE, i.e. the maximum number supported for simultaneous UL data streams transmission. The UE can provide its capacity regarding the supported number of layers to the BS in advance (not shown in FIG. 3).

Detailed features of the present disclosure will be described in detail below.

According to an embodiment, the UE may be configured to transmit multiple SRSs simultaneously in one same symbol. For the UE with such a feature, the BS can configure N SRS resources in a group such that at least two SRS resources of the N SRS resources occupy a same symbol. Such a configuration would advantageously reduce the latency.

For example, the UE can let the BS know whether it supports simultaneous transmission of multiple SRSs for non-codebook in a same symbol and/or a maximum number supported for simultaneous SRS transmission in one symbol. For example, the UE can transmit capability information to the BS indicating whether it supports simultaneous transmission of multiple SRSs for non-codebook in a same symbol as well as a maximum number supported for simultaneous SRS transmission in one symbol if the UE does supports such a feature. Alternatively, the UE can simply transmit capability information indicating the maximum number supported for simultaneous SRS transmission in one symbol without explicitly indicating whether the UE supports simultaneous SRS transmission. In this case, if the maximum number equals to one, the capability information implies that the UE does not support simultaneous SRS transmission, and if the maximum number is larger than one, the capability information implies that the UE supports simultaneous SRS transmission.

According to the present disclosure, the BS can determine how many SRS resources can occupy a same symbol based on the UE capability. For example, the BS can configure N SRS resources in a group such that every K(K<=N and being an integer) out of N SRS resources occupy a same symbol, where K equals to the maximum number of simultaneously transmitted SRSs supported by the UE. Note that, in the case where the UE supports simultaneous SRS transmission, the BS does not have to configure more than one SRS resources for one same symbol, for example, for the scenarios where the requirement regarding latency is not strict. For another example, in the case where the UE supports to simultaneously transmit K SRSs in one symbol, the BS can configure N SRS resources in a group in which each set of L (being an integer) sets of K SRS resources occupies a same symbol, while the rest SRS resources (i.e. (N−L*K) SRS resources) each occupies a symbol separately.

FIG. 4A illustrates a group of SRS resources in which each SRS resource occupies a separate symbol. FIG. 4B illustrates a group of SRS resources in which every two SRS resources occupy a same symbol. Particularly, in FIG. 4B, SRS resource 1 and SRS resource 2 occupy a same symbol, SRS resource 3 and SRS resource 4 occupy a same symbol, SRS resource 5 and SRS resource 6 occupy a same symbol and SRS resource 7 and SRS resource 8 occupy a same symbol. As can be understood from FIG. 4A and FIG. 4B, the total time for SRS transmission can be reduced if some of the SRS resources occupy a same symbol.

According to an embodiment, N SRS resources in a group can be configured such that at least two SRS resources of the N SRS resources occupy a same Physical Resource Block (PRB). Such a configuration would advantageously reduce the occupation of frequency resources. Preferably, N SRS resources in a group can be configured such that at least two SRS resources occupy a same symbol and a same PRB. In other words, at least two SRS resources can be configured with respective ports which share the same time resource and the same frequency resource but with different orthogonal codes.

Some aspects of the present disclosure have been described above. Note the above detailly explained aspects can apply to any of periodic/semi-persistent/aperiodic SRS transmission.

According to the present disclosure, the group of N SRS resources can be configured by configuring one or more SRS resource set, each SRS resource set may consist of a plurality of SRS resources. Based on the related standard (e.g. 3GPP standard), only some symbols (e.g. four last symbols) in a slot can be used for SRS resources. As described above, SRS can be transmitted periodically, aperiodically, or semi-persistently. For periodic and semi-persistent SRS transmission, one SRS resource set is allowed to be configured across several slots (e.g. using the available symbols in each slot). Therefore, according to the present disclosure, the BS can configure one SRS resource set for periodic or semi-persistent SRS transmission containing a group of N (N>4) SRS resources to support more than 4 layers non-codebook based UL transmission.

While, based on the related standard (e.g. 3GPP standard), one SRS resource set has to be configured within a same slot for aperiodic SRS transmission. Therefore, one SRS resource set may not be able to contain the required number of SRS resources. In view of this, the present disclosure provides that multiple SRS resource sets for aperiodic SRS transmission together containing N (N>4) SRS resources can be configured together as a group of N SRS resources to support more than 4 layers non-codebook based UL transmission. Note that, although for periodic or semi-persistent SRS transmission, the group of N SRS resources can be configured in one SRS set, the group of N SRS resources can alternatively be configured in multiple SRS resource sets. In the latter case, the following described aspects for aperiodic SRS transmission also apply to the periodic or semi-persistent SRS transmission.

The number of SRS resource sets can depend on the number of available symbols in one slot, the times of SRS repetition and the number of simultaneous SRS transmission in one symbol as previously described. For example, consuming the following for aperiodic SRS transmission: (1) the BS configures SRS resources to support 8 layers non-codebook based UL transmission; (2) only four last symbols in one slot can be used for SRS resources; (3) the SRS is transmitted without repetition; and (4) the UE does not support simultaneous SRS transmission in one symbol, two SRS resource sets each consisting four SRS resources can be configured. FIG. 5 illustrates the SRS resource configuration under the above assumption. For simplicity, SRS resources 1-8 are represented as SRSs 1-8 in FIG. 5. For example, as shown in FIG. 5, SRS resource 1-SRS resource 4 can be configured in a first SRS resource set in slot n, and SRS resource 5-SRS resource 8 can be configured in a second SRS resource set in slot n+1. SRS resource 1-SRS resource 8 together consist the group of SRSs for aperiodic SRS transmission.

According to the present disclosure, the N (N>4) SRS resources can be configured evenly in more than one SRS resource sets used for aperiodic SRS transmission. In other words, each of the SRS resource sets used for aperiodic SRS transmission is configured with a same number of SRS resources. FIG. 5 is an example for such a configuration. Such a configuration advantageously simplifies the implementation at the UE side.

Alternatively and preferably, the N (N>4) SRS resources can be configured, with any combination, in more than one SRS resource sets used for aperiodic SRS transmission. In other words, any suitable number of SRS resource sets each containing any suitable number of SRS resources can be configured, as long as the total number of SRS resources is N. This configuration would bring more flexibility, especially because the available symbols for SRS resources may vary from different slots. For example, assuming that BS configures SRS resources to support 8 layers non-codebook based UL transmission and there are only three symbols available for SRS resources in slot n while there are five symbols available for SRS resources in slot n+1, the BS can configure a first SRS resource set with three SRS resources and configure a second SRS resources set with five SRS resources.

According to the present disclosure, for aperiodic SRS transmission, if more than one SRS resource sets are configured as a group of N (N>4) SRS resources, some restrictions may need to be ensured.

For example, as described above, UE would calculate precoders for SRSs based on the CSI-RS. Only if the calculation is performed based on a same downlink channel (e.g. the channel associated with a specific Non-Zero Power (NZP) CSI-RS resource), the BS is able to compare the channel qualities of the received SRSs. In the at least one RRC signaling indicating SRS resource configuration, the SRS resource set to be configured will be associated with a respective NZP-CSI-RS resource. In the case where more than one SRS resource sets are configured as a group of N (N>4) SRS resources for aperiodic SRS transmission, to keep the precoders corresponding to the configured SRS resources being calculated based on a same downlink channel, the more than one SRS resource sets may be required to be associated with a same NZP CSI-RS resource.

For another example, to keep the BS to compare the channel qualities of the received SRSs on a same power control basis, same power control parameters may be required to be configured for the more than one SRS resource sets as a group of N (N>4) SRS resources for aperiodic transmission. For example, the power control parameters may at least comprise one or more of alpha (i.e. a targeted received power energy at the BS side), p0 (i.e. a ratio of partial path loss compensation), pathlossReferenceRS (i.e. a reference signal for path loss estimate), and srs-PowerControlAdjustmentStates (i.e. power control adjustment state for SRS transmission).

For another example, in the RRC signaling for SRS resource configuration, each SRS resource set for aperiodic transmission will be associated with at least one trigger state (e.g. via the parameter aperiodicSRS-REsourceTrigger, or via the parameter aperiodicSRS-ResourceTriggerList in the case where several trigger states can be associated with an aperiodic SRS resource set). For aperiodic SRS transmission, the SRS transmission will be triggered by DCI containing a field (e.g. SRS request) indicating a trigger state, such that the SRS resource set with the indicated trigger state will be triggered, in other words, SRS transmission on the SRS resource(s) in the SRS resource set with the indicated trigger state will be triggered. In the case where more than one SRS resource sets are configured as a group of N (N>4) SRS resources for aperiodic SRS transmission, to ensure all the more than one SRS resources sets will be triggered together as a group, the more than one SRS resource sets may be required to be configured with a same SRS trigger state. That is, each time there is a need to trigger aperiodic SRS transmission, either all the more than one SRS resource sets are triggered or none of the more than one SRS resource sets is triggered. Particularly, for example, the more than one SRS resource sets may be required to be configured with a same value for the parameter aperiodicSRS-ResourceTrigger or a same value for an entry in the parameter AperiodicSRS-ResourceTriggerList.

The UE would transmit SRSs precoded using respective precoders. As described above, in non-codebook based transmission, the UE would calculate precoder(s) for uplink transmission based on the received CSI-RS(s) at the UE side. Therefore, timeline relaxation is needed between the aperiodic SRS transmission and the reception of CSI-RS on the associated NZP-CSI-RS resource, so as to ensure a time period at least enough for the UE to calculate the precoders. According to the present disclosure, such timeline relaxation can be defined by a gap from the last symbol of the reception of the NZP-CSI-RS Resource associated with the group of N SRS resources configured for aperiodic SRS transmission and the first symbol of the aperiodic SRS transmission. For example, the unit for such a gap can be symbol. For example, the UE may not update the SRS precoding information (e.g. previously calculated precoders) if the gap is less than M (being an integer) Orthogonal Frequency Division Multiplexing (OFDM) symbols.

In order to support more than 4 layers non-codebook based UL transmission, more than 4 SRS resources are configured as a group. In view of this, SRSs are to be transmitted on more SRS resources, and the UE needs a longer time period to calculate the corresponding precoders for aperiodic SRS transmission, comparing to the solutions supporting less layers. Therefore, the number M of the OFDM symbols of the gap can take a relatively large value. For example, M can be larger than 42, i.e. M>42, that is the gap can contain more than 42 symbols. Note that the time length of a symbol varies depending on Sub-Carrier Spacing (SCS) in 5G NR. The smaller the SCS is, the longer time the symbol occupies. Since in 5G NR, downlink and uplink may take different values of SCS, the time length of a symbol can be calculated based on the minimum SCS such that the timeline relaxation between the aperiodic SRS transmission and the reception of CSI-RS on the associated NZP-CSI-RS resource can be calculated as a larger value to ensure enough time for the UE to calculate the precoders. For example, the time length of a symbol (as well as the time length of the M OFDM symbols) can be based on the minimum one of an SCS of the NZP-CSI-RS and an SCS of the SRSs to be aperiodically transmitted.

According to the present disclosure, the number M of OFDM symbols in the gap from the last symbol of the reception of the NZP-CSI-RS Resource associated with the group of N SRS resources configured for aperiodic SRS transmission and the first symbol of the aperiodic SRS transmission can be reported as part of UE capability from the UE to the BS. This can bring certain flexibility, and the most appropriate value of M can be determined based on the capability (e.g. capability regarding computation) of each specific UE. Alternatively, the number M of OFDM symbols can be defined as a fixed value in advance. For example, the value of M can be hardcoded in the specification of the related standard.

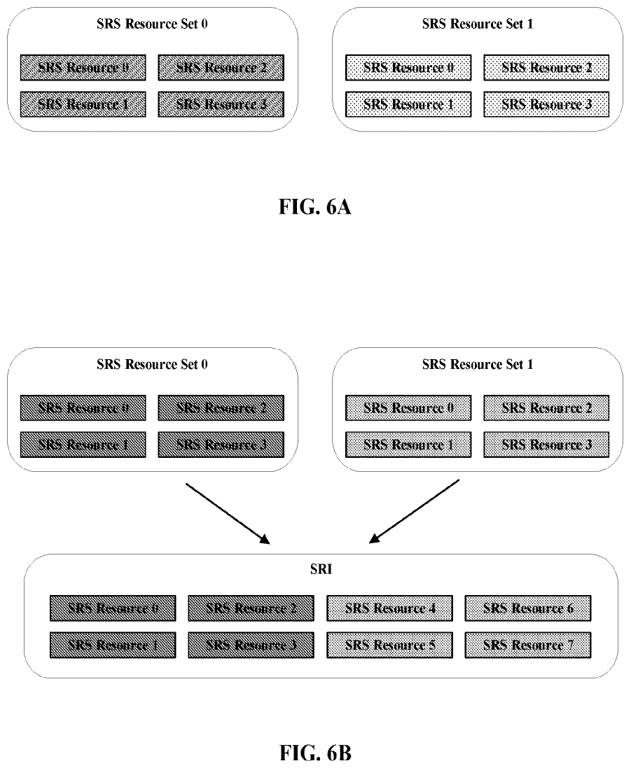

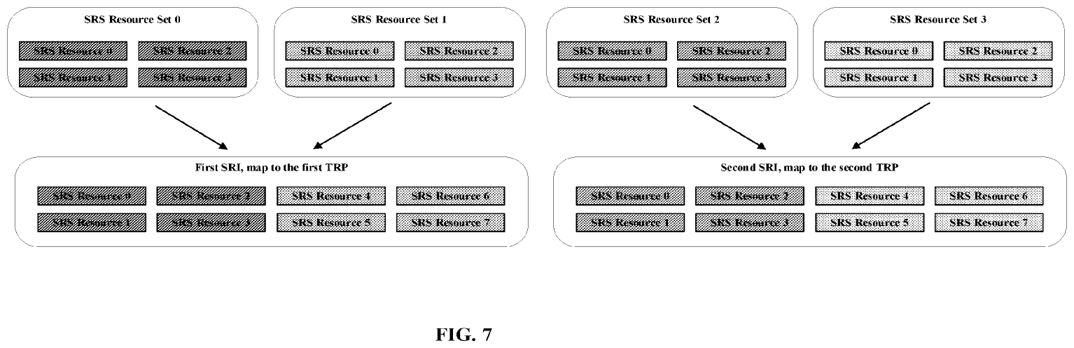

When configuring the SRS resources, each SRS resource set will be assigned an identifier (e.g. ID) and each SRS resources will be assigned an identifier (e.g. ID) within each SRS resource set. In other words, the SRS resources belonging to different SRS resource sets are ordered separately and may share a same identifier. FIG. 6A illustrates the assignment of identifiers for SRS resource sets and SRS resources. As shown in FIG. 6A, for two SRS resource sets, i.e. SRS resource set with ID 0 and SRS resource set with ID 1, even if these two sets are configured as a group for aperiodic SRS transmission, the SRS resources within each sets are assigned with respective IDs based on separate ordering. For example, the SRS resources within the SRS resource set with ID 0 are assigned with IDs 0, 1, 2 and 3 respectively, and the SRS resources within the SRS resource set with ID 1 are also assigned with IDs 0, 1, 2 and 3 respectively.

As described above, upon receiving the SRSs transmitted on the configured group of SRS resources, the BS will transmit DCI containing a field (e.g. SRS indicator (SRI)) indicating the ID(s) of the selected SRS(s) to the UE so as to indicate the UE to use precoding information corresponding to the indicated SRS(s) (e.g. the same precoder(s) with that used for transmitting the indicated SRS(s)) for uplink data. According to the present disclosure, since there could be more than one SRS resource sets configured as a group of SRS resources for aperiodic SRS transmission, there is a need to let the UE understand the indicated ID(s) corresponds to which SRS resource(s) in which SRS resource set(s).

According to the present disclosure, the N SRS resources configured as a group in more than one SRS resource sets can be ordered according to the identifiers of the SRS resource sets. For example, the SRS resources within the SRS resource set with a smaller ID can possess smaller order and the SRS resources within the SRS resource set with a larger ID can possess larger order. Alternatively, the SRS resources within the SRS resource set with a smaller ID can possess larger order and the SRS resources within the SRS resource set with a larger ID can possess smaller order. In the DCI, instead of indicating the initial identifier of each SRS resource assigned in the at least one RRC signaling for configuring SRS resources, an identifier corresponding to the general order can be indicated. As shown in FIG. 6B, for example, in the field SRI of DCI, the identifiers for SRS Resources 0-3 in SRS Resource Set 0 can be 0-3, and the identifiers for SRS Resources 0-3 in SRS Resource Set 1 can be 4-7. For example, if the BS selects SRS Resource 0 in SRS Resource Set 0 as well as SRS Resource 1 and SRS Resource 3 in SRS Resource Set 1, the BS can indicate identifiers 0, 5 and 7 in the field SRI of DCI so as to indicate the UE to transmit uplink data using precoding information corresponding to the indicated SRSs.

There are scenarios which enables communication between the wireless device and more than one Transmission and Reception Points (TRP) of the BS. For example, multiple TRPs of the BS can perform joint transmission. Under such multi-TRP operation, some specific configuration may be required to support non-Codebook based UL transmission for more than 4 layers. Note that the aforementioned features also apply to multi-TRP operation.

According to the present disclosure, consuming the UE supports N layers at most for non-codebook based uplink transmission, for each TRP, the BS can configure a group of up to N SRS resources for non-codebook, and a total number of the SRS resources configured for all the TRPs of the BS is no larger than N. For example, the BS can decide how many SRS resources to be configured for each TRP for example, based on the average communication quality between the UE and a respective TRP and the capability of the TRP, etc., as long as a total number of all the SRS resources configured for all the TRPs of the BS is equal to or less than the number of layers supported by the UE.

Particularly, as described above, multiple SRS resource sets may be required for configuring a group of SRS resources for aperiodic SRS transmission (or in some cases, for periodic/semi-persistent SRS transmission). Still consuming the UE supports N layers at most for non-codebook based uplink transmission, for each TRP, the BS can configure a group of up to N SRS resources for non-codebook in at least one SRS resource set used for aperiodic SRS transmission, and a total number of the SRS resources configured for all the TRPs of the BS is no larger than N.

FIG. 7 illustrates an example of SRS resource configuration for aperiodic SRS transmission for non-codebook based UL transmission.

In the example of FIG. 7, it is assumed that the UE supports 16 layers at most for non-codebook based uplink transmission and the scenario enables communication between the UE and two TRPs of the BS. In the illustrated example, the BS configured 8 SRS resources for each TRP and each group of 8 SRS resources are configured in two SRS resource sets for a corresponding TRP. Particularly, SRS resource set with ID 0 and ID 1 are configured for the first TRP and SRS resource set with ID 2 and ID 3 are configured for the second TRP. After having sounded the uplink channels, the BS can use two separate SRIs (e.g. first SRI and second SRI in FIG. 7) in two separate DCI to indicate the UE the precoders to be used for uplink data transmission. Similarly to the above description, the SRS resources configured as a group in more than one SRS resource sets for each TRP can be ordered according to the identifiers of the SRS resource sets, and identifier(s) corresponding to the general order can be indicated in the respective SRI for each TRP.

Note that although FIG. 7 illustrates the SRS resources are evenly configured for each TRP, the number of SRS resources for each TRP can be arbitrarily configured according to actual conditions. For example, under the same assumption of FIG. 7 (i.e. 2 TRP operation and 16 layers), the first TRP can be configured with 10 SRS resources and the second TRP can be configured with 6 SRS resources. For example, the number of SRS resources configured for each TRP can be determined based on multiple factors (e.g. the capability of the TRP, the average communication quality between the TRP and the UE, etc.)

As illustrated in FIG. 7, in the SRI, only the identifier(s) corresponding to the general order of the SRS resource(s) for a corresponding TRP is indicated without explicitly pointing out the indicated SRS resource(s) belongs to which group of SRS resources (i.e. set(s) of SRS resources configured as a group for a TRP). Therefore, the UE is required to be able to know the mapping between the SRI and a corresponding SRS resource group (i.e. corresponding SRS resource set(s) for aperiodic SRS transmission consisting the group), so as to be able to know which specific SRS resources for example among the configured 16 SRS resources in FIG. 7 the indicated SRS resources in the SRI refers to. Similarly, the UE is also required to be able to know the mapping between Quasi-collocation (QCL)/Spatial relation and a corresponding SRS resource group (i.e. corresponding SRS resource set(s) consisting the group).

There can be several ways to let the UE know such mapping.

For example, the group of SRS resource set(s) configured for a TRP can be associated with a same SRS trigger state and the different groups of SRS resource set(s) configured for different TRPs can be associated with different SRS trigger states, such that mapping between an SRI/QCL/Spatial relation and a corresponding group of SRS resource set(s) can be determined based on the SRS trigger state. Particularly, take the mapping between SRI and a corresponding group of SRS resource set(s) as an example. Since the UE knows the mapping between a DCI and a TRP, the UE is able to know the mapping between an SRI contained in a DCI and a TRP. Therefore, when receiving an SRI, the UE can understand which SRS resource sets are associated with the corresponding TRP based on the value of SRS trigger states.

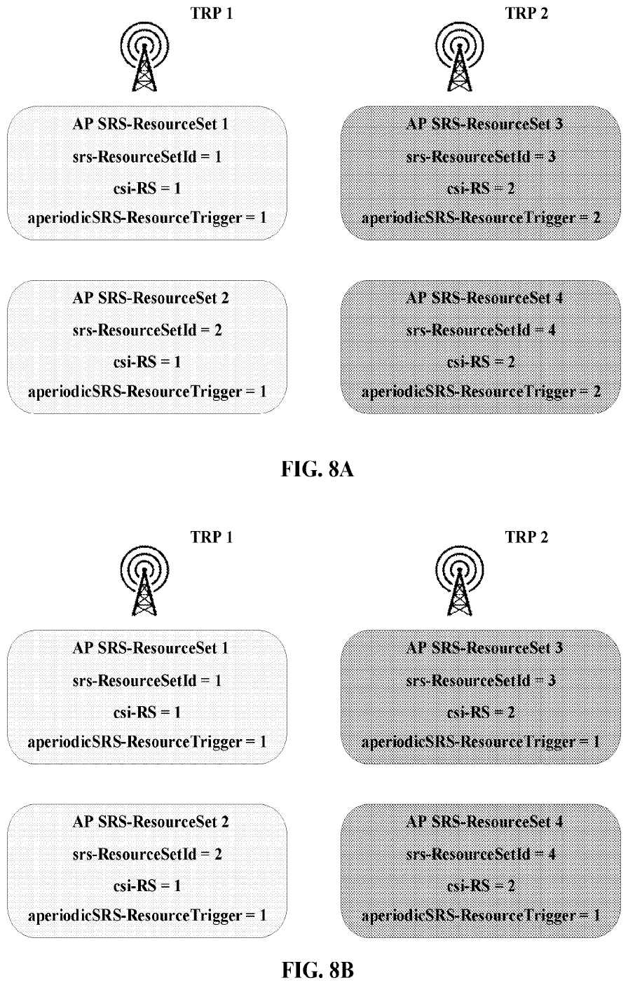

As illustrated in FIG. 8A, SRS resource sets with ID 1 and ID 2 for aperiodic (AP) SRS transmission are configured for TRP 1 and AP SRS resource sets with ID 3 and ID 4 are configured for TRP 2. The SRS trigger state with value 1 is associated with AP SRS Resource Set 1 and AP SRS Resource Set 2, while the SRS trigger state with value 2 is associated with AP SRS Resource Set 3 and AP SRS Resource Set 4.

Under this solution, the BS needs to transmit several DCI each with a different SRS trigger state corresponding to a TPR so as to trigger SRS transmission towards these TRPs.

For another example, different groups of SRS resource set(s) configured for different TRPs can be associated with a same SRS trigger state, and mapping between an SRI/QCL/Spatial relation and a corresponding group of SRS resource set(s) can be determined based on a predetermined rule. For example, for two TRPs, the predetermined rule may be the first k sets with smaller IDs correspond to TRP 1 and the rest 1 sets with larger IDs correspond to TRP2. Particularly, take the mapping between SRI and a corresponding group of SRS resource set(s) as an example. Since the UE knows the mapping between a DCI and a TRP, the UE is able to know the mapping between an SRI contained in a DCI and a TRP. Besides, since an SRS resource set will be associated with an NZP-CSI-RS during SRS resource configuration, and each NZP-CSI-RS is associated with a specific TRP. Therefore, when receiving an SRI, the UE can determine which SRS resource sets are associated with the corresponding TRP.

As illustrated in FIG. 8B, SRS resource sets with ID 1 and ID 2 for aperiodic (AP) SRS transmission are configured for TRP 1 and AP SRS resource sets with ID 3 and ID 4 are configured for TRP 2, and the SRS trigger state with value 1 is associated with all the AP SRS Resource Set 1-4. Besides, the NZP-CSI-RSs for AP SRS Resource Sets 1-2 and AP SRS Resource Sets 3-4 are different.

Under this solution, the BS can trigger SRS transmission towards multiple TRPs by transmitting only one DCI, which can reduce the overhead comparing to the solution assigning different SRS trigger states for SRS resources sets for different TRPs.

Various aspects of the present disclosure have been described above. The present disclosure can be realized in various embodiments.

Embodiments contemplated herein include an apparatus comprising means to perform one or more elements of the method as described above. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method as described above. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method as described above. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method as described above. This apparatus may be, for example, an apparatus of a UE (such as a wireless device 202 that is a UE, as described herein).

Embodiments contemplated herein include a signal as described in or related to one or more elements of the method as described above.

Embodiments contemplated herein include a computer program or computer program product comprising instructions, wherein execution of the program by a processor is to cause the processor to carry out one or more elements of the method as described above. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of the method as described above. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method as described above. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method as described above. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method as described above. This apparatus may be, for example, an apparatus of a base station (such as a network device 218 that is a base station, as described herein).

Embodiments contemplated herein include a signal as described in or related to one or more elements of the method as described above.

Embodiments contemplated herein include a computer program or computer program product comprising instructions, wherein execution of the program by a processing element is to cause the processing element to carry out one or more elements of the method as described above. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

The above has described in detail the SRS enhancement to support more than 4 layers non-codebook based uplink transmission. In addition, the present disclosure can also have any of the configurations below.

(1) A wireless device, comprising:
at least one antenna;
at least one radio coupled to the at least one antenna; and
a processor coupled to the at least one radio;
wherein the processor is configured to:
   receive, via the at least one radio, at least one Radio Resource Control (RRC) signaling from a cellular base station, wherein, the at least one RRC signaling configures at least one group of N Sounding Reference Signal (SRS) resources for non-codebook, N>4, and each SRS resource is configured with one port; and
   transmit, via the at least one radio, SRSs to the cellular base station on the configured group of SRS resources, wherein each SRS is transmitted on one SRS resource of the configured group of SRS resources.
      (2) The wireless device of (1), wherein
the processor is further configured to transmit, via the at least one radio, capability information to the cellular base station indicating whether the wireless device supports simultaneous transmission of multiple SRSs for non-codebook in a same symbol and/or a maximum number of supported simultaneously transmitted SRSs for non-codebook in one symbol; and
at least two SRS resources of the N SRS resources occupy a same symbol in the case where the wireless device supports simultaneous transmission of multiple SRSs for non-codebook in a same symbol.
   (3) The wireless device of (1) or (2), wherein
at least two SRS resources of the N SRS resources occupy a same Physical Resource Block (PRB).
   (4) The wireless device of (1) or (2), wherein
a first group of N SRS resources are configured in one SRS resource set used for periodic or semi-persistent SRS transmission.
   (5) The wireless device of (1) or (2), wherein
a second group of N SRS resources are configured in more than one SRS resource sets used for aperiodic SRS transmission.
   (6) The wireless device of (5), wherein
the N SRS resources are configured, with any combination, in said more than one SRS resource sets used for aperiodic SRS transmission; or
the N SRS resources are configured evenly in said more than one SRS resource sets used for aperiodic SRS transmission.
   (7) The wireless device of (5), wherein for said more than one SRS resource sets, one or more of the following is configured:
said more than one SRS resource sets are associated with a same Non-Zero Power (NZP) Channel State Information Reference Signal (CSI-RS) Resource;
said more than one SRS resource sets are configured with same power control parameters; and
said more than one SRS resource sets are configured with a same SRS trigger state.
   (8) The wireless device of (5), wherein
the processor is further configured to receive from the cellular base station, via the at least one radio, Downlink Control Information (DCI) triggering aperiodic SRS transmission, and wherein the processor is further configured not to update the SRS precoding information if a gap from the last symbol of the reception of the Non-Zero Power (NZP) Channel State Information Reference Signal (CSI-RS) Resource associated with the second group of N SRS resources and the first symbol of the aperiodic SRS transmission is less than M Orthogonal Frequency Division Multiplexing (OFDM) symbols, wherein M>42 and a time length of the M symbols is calculated based on the minimum one of a Sub-Carrier Spacing (SCS) of the NZP-CSI-RS and an SCS of the SRSs to be aperiodically transmitted.
   (9) The wireless device of (8), wherein
the processor is further configured to transmit, via the at least one radio, capability information to the cellular base station indicating the value of M, or
the value of M is defined as a fixed value in advance.
   (10) The wireless device of (5), wherein
the N SRS resources configured in said more than one SRS resource sets are ordered according to identifiers of the SRS resource sets.
   (11 ) The wireless device of (10), wherein, the processor is further configured to receive from the cellular base station, via the at least one radio, Downlink Control Information (DCI) indicating at least one SRS resource from the N SRS resources by indicating at least one identifier based on the order corresponding to the at least one SRS resource, and
in response to the DCI, transmit, via the at least one radio, uplink data using precoding information corresponding to the at least one SRS resource.
   (12) The wireless device of (1) or (2), wherein for a scenario enabling communication between the wireless device and more than one Transmission and Reception Points (TRP) of the cellular base station:
for each TRP, a third group of up to N SRS resources for non-codebook is configured in at least one SRS resource set used for aperiodic SRS transmission, and
a total number of the SRS resources configured for all the TRPs of the cellular base station is no larger than N,
wherein, N represents a maximum number of layers supported by the wireless device for uplink transmission.
   (13) The wireless device of (12), wherein for the scenario enabling communication between the wireless device and more than one TRPs of the cellular base station:

SRS resource sets configured for a TRP are associated with a same SRS trigger state and SRS resource sets configured for different TRPs are associated with different SRS trigger states, and mapping between an SRS Resource Indicator (SRI)/Quasi-collocation (QCL)/Spatial relation and a specific SRS resource set is determined based on the SRS trigger state; or

SRS resource sets configured for different TRPs are associated with a same SRS trigger state, and mapping between an SRS Resource Indicator (SRI)/Quasi-collocation (QCL)/Spatial relation and a specific SRS resource set is determined based on a predetermined rule.

(14) A cellular base station, comprising:
at least one antenna;
at least one radio coupled to the at least one antenna; and
a processor coupled to the at least one radio;
wherein the processor is configured to:
   transmit, via the at least one radio, at least one Radio Resource Control (RRC) signaling to a wireless device, wherein, the at least one RRC signaling configures at least one group of N Sounding Reference Signal (SRS) resources for non-codebook, N>4, and each SRS resource is configured with one port; and
   receive, via the at least one radio, SRSs from the wireless device on the configured group of SRS resources, wherein each SRS is received on one SRS resource of the configured group of SRS resources.
      (15) The cellular base station of (14), wherein
the processor is further configured to receive, via the at least one radio, capability information from the wireless device indicating whether the wireless device supports simultaneous transmission of multiple SRSs for non-codebook in a same symbol and/or a maximum number of supported simultaneously transmitted SRSs for non-codebook in one symbol; and
at least two SRS resources of the N SRS resources occupy a same symbol in the case where the wireless device supports simultaneous transmission of multiple SRSs for non-codebook in a same symbol.
   (16) The cellular base station of (14) or (15), wherein
at least two SRS resources of the N SRS resources occupy a same Physical Resource Block (PRB).
   (17) The cellular base station of (14) or (15), wherein
a first group of N SRS resources are configured in one SRS resource set used for periodic or semi-persistent SRS transmission.
   (18) The cellular base station of (14) or (15), wherein
a second group of N SRS resources are configured in more than one SRS resource sets used for aperiodic SRS transmission.
   (19) The cellular base station of (18), wherein
the N SRS resources are configured, with any combination, in said more than one SRS resource sets used for aperiodic SRS transmission; or
the N SRS resources are configured evenly in said more than one SRS resource sets used for aperiodic SRS transmission.
   (20) The cellular base station of (18), wherein for said more than one SRS resource sets, one or more of the following is configured:
said more than one SRS resource sets are associated with a same Non-Zero Power (NZP) Channel State Information Reference Signal (CSI-RS) Resource;
said more than one SRS resource sets are configured with same power control parameters; and
said more than one SRS resource sets are configured with a same SRS trigger state.
   (21) The cellular base station of (18), wherein
the N SRS resources configured in said more than one SRS resource sets are ordered according to identifiers of the SRS resource sets.
(22) The cellular base station of (21), wherein, the processor is further configured to transmit to the wireless device, via the at least one radio, Downlink Control Information (DCI) indicating at least one SRS resource from the N SRS resources by indicating at least one identifier based on the order corresponding to the at least one SRS resource, and receive, via the at least one radio, uplink data using precoding information corresponding to the at least one SRS resource transmitted in response to the DCI.
   (23) The cellular base station of (14) or (15), wherein for a scenario enabling communication between the wireless device and more than one Transmission and Reception Points (TRP) of the cellular base station:
for each TRP, a third group of up to N SRS resources for non-codebook is configured in at least one SRS resource set used for aperiodic SRS transmission, and
a total number of the SRS resources configured for all the TRPs of the cellular base station is no larger than N,
wherein, N represents a maximum number of layers supported by the wireless device for uplink transmission.
   (24) The cellular base station of (23), wherein for the scenario enabling communication between the wireless device and more than one TRPs of the cellular base station:
SRS resource sets configured for a TRP are associated with a same SRS trigger state and SRS resource sets configured for different TRPs are associated with different SRS trigger states, and mapping between an SRS Resource Indicator (SRI)/Quasi-collocation (QCL)/Spatial relation and a specific SRS resource set is determined based on the SRS trigger state; or
SRS resource sets configured for different TRPs are associated with a same SRS trigger state, and mapping between an SRS Resource Indicator (SRI)/Quasi-collocation (QCL)/Spatial relation and a specific SRS resource set is determined based on a predetermined rule.
   (25) A method for a wireless device, comprising:
receiving at least one Radio Resource Control (RRC) signaling from a cellular base station, wherein, the at least one RRC signaling configures at least one group of N Sounding Reference Signal (SRS) resources for non-codebook, N>4, and each SRS resource is configured with one port; and
transmitting SRSs to the cellular base station on the configured group of SRS resources, wherein each SRS is transmitted on one SRS resource of the configured group of SRS resources.
   (26) The method of (25), wherein
the method further comprising transmitting capability information to the cellular base station indicating whether the wireless device supports simultaneous transmission of multiple SRSs for non-codebook in a same symbol and/or a maximum number of supported simultaneously transmitted SRSs for non-codebook in one symbol; and
at least two SRS resources of the N SRS resources occupy a same symbol in the case where the wireless device supports simultaneous transmission of multiple SRSs for non-codebook in a same symbol.
   (27) The method of (25) or (26), wherein
a first group of N SRS resources are configured in one SRS resource set used for periodic or semipersistent SRS transmission.
   (28) The method of (25) or (26) wherein
a second group of N SRS resources are configured in more than one SRS resource sets used for aperiodic SRS transmission.
   (29) The method of (28), wherein
the N SRS resources are configured, with any combination, in said more than one SRS resource sets used for aperiodic SRS transmission; or
the N SRS resources are configured evenly in said more than one SRS resource sets used for aperiodic SRS transmission.
   (30) The method of (28), wherein for said more than one SRS resource sets, one or more of the following is configured:
said more than one SRS resource sets are associated with a same Non-Zero Power (NZP) Channel State Information Reference Signal (CSI-RS) Resource;
said more than one SRS resource sets are configured with same power control parameters; and said more than one SRS resource sets are configured with a same SRS trigger state.
   (31) The method of (28), wherein
the method further comprising receiving from the cellular base station Downlink Control Information (DCI) triggering aperiodic SRS transmission, and wherein
the method further comprising not to update the SRS precoding information if a gap from the last symbol of the reception of the Non-Zero Power (NZP) Channel State Information Reference Signal (CSI-RS) Resource associated with the second group of N SRS resources and the first symbol of the aperiodic SRS transmission is less than M Orthogonal Frequency Division Multiplexing (OFDM) symbols, wherein M>42 and a time length of the M symbols is calculated based on the minimum one of a Sub-Carrier Spacing (SCS) of the NZP-CSI-RS and an SCS of the SRSs to be aperiodically transmitted.
   (32) The method of (31), wherein
The value of M is transmitted to the cellular base station by the wireless device, or
the value of M is defined as a fixed value in advance.
   (33) The method of (28), wherein
the N SRS resources configured in said more than one SRS resource sets are ordered according to identifiers of the SRS resource sets.
   (34) The method of (25) or (26), wherein for a scenario enabling communication between the wireless device and more than one Transmission and Reception Points (TRP) of the cellular base station:
for each TRP, a third group of up to N SRS resources for non-codebook is configured in at least one SRS resource set used for aperiodic SRS transmission, and
a total number of the SRS resources configured for all the TRPs of the cellular base station is no larger than N, and
SRS resource sets configured for different TRPs are associated with a same SRS trigger state or different SRS trigger states,
wherein, N represents a maximum number of layers supported by the wireless device for uplink transmission.
   (35) A method for a cellular base station, comprising
transmitting at least one Radio Resource Control (RRC) signaling to a wireless device, wherein, the at least one RRC signaling configures at least one group of N Sounding Reference Signal (SRS) resources for non-codebook, N>4, and each SRS resource is configured with one port; and
receiving SRSs from the wireless device on the configured group of SRS resources, wherein each SRS is received on one SRS resource of the configured group of SRS resources.
   (36) The method of (35), wherein
the method further comprising receiving capability information from the wireless device indicating whether the wireless device supports simultaneous transmission of multiple SRSs for non-codebook in a same symbol and/or a maximum number of supported simultaneously transmitted SRSs for non-codebook in one symbol; and
at least two SRS resources of the N SRS resources occupy a same symbol in the case where the wireless device supports simultaneous transmission of multiple SRSs for non-codebook in a same symbol.
   (37) The method of (35) or (36), wherein
a first group of N SRS resources are configured in one SRS resource set used for periodic or semi-persistent SRS transmission.
   (38) The method of (35) or (36), wherein
a second group of N SRS resources are configured in more than one SRS resource sets used for aperiodic SRS transmission.
   (39) The method of (38), wherein
the N SRS resources are configured, with any combination, in said more than one SRS resource sets used for aperiodic SRS transmission; or
the N SRS resources are configured evenly in said more than one SRS resource sets used for aperiodic SRS transmission.
   (40) The method of (38), wherein for said more than one SRS resource sets, one or more of the following is configured:
said more than one SRS resource sets are associated with a same Non-Zero Power (NZP) Channel State Information Reference Signal (CSI-RS) Resource;
said more than one SRS resource sets are configured with same power control parameters; and
said more than one SRS resource sets are configured with a same SRS trigger state.
   (41) The method of (38), wherein
the N SRS resources configured in said more than one SRS resource sets are ordered according to identifiers of the SRS resource sets.
   (42) The method of (35) or (36), wherein for a scenario enabling communication between the wireless device and more than one Transmission and Reception Points (TRP) of the cellular base station:
for each TRP, a third group of up to N SRS resources for non-codebook is configured in at least one SRS resource set used for aperiodic SRS transmission, and
a total number of the SRS resources configured for all the TRPs of the cellular base station is no larger than N, and
SRS resource sets configured for different TRPs are associated with a same SRS trigger state or different SRS trigger states,
wherein, N represents a maximum number of layers supported by the wireless device for uplink transmission.
   (43) An apparatus, comprising:
a processor configured to cause a wireless device to:
   receive, via the at least one radio, at least one Radio Resource Control (RRC) signaling from a cellular base station, wherein, the at least one RRC signaling configures at least one group of N Sounding Reference Signal (SRS) resources for non-codebook, N>4, and each SRS resource is configured with one port; and
   transmit, via the at least one radio, SRSs to the cellular base station on the configured group of SRS resources, wherein each SRS is transmitted on one SRS resource of the configured group of SRS resources.
      (44) A computer-readable storage medium storing program instructions, wherein the program instructions, when executed by a computer system, cause the computer system to perform any method of (25)-(34).
      (45) A computer-readable storage medium storing program instructions, wherein the program instructions, when executed by a computer system, cause the computer system to perform any method of (35)-(42).
      (46) A computer program product, comprising program instructions which, when executed by a computer, cause the computer to perform any method of (25)-(34).
      (47) A computer program product, comprising program instructions which, when executed by a computer, cause the to perform method computer any of (35)-(42).

1. A wireless device, comprising:
at least one antenna;
at least one radio coupled to the at least one antenna; and
a processor coupled to the at least one radio;
wherein the processor is configured to:
receive, via the at least one radio, at least one Radio Resource Control (RRC) signaling from a cellular base station, wherein, the at least one RRC signaling configures at least one group of N Sounding Reference Signal (SRS) resources for non-codebook, N>4, and each SRS resource is configured with one port; and
transmit, via the at least one radio, SRSs to the cellular base station on the configured group of SRS resources, wherein each SRS is transmitted on one SRS resource of the configured group of SRS resources.

2. The wireless device of claim 1, wherein
the processor is further configured to transmit, via the at least one radio, capability information to the cellular base station indicating whether the wireless device supports simultaneous transmission of multiple SRSs for non-codebook in a same symbol and/or a maximum number of supported simultaneously transmitted SRSs for non-codebook in one symbol; and
at least two SRS resources of the N SRS resources occupy a same symbol in the case where the wireless device supports simultaneous transmission of multiple SRSs for non-codebook in a same symbol.

3. The wireless device of claim 1, wherein
at least two SRS resources of the N SRS resources occupy a same Physical Resource Block (PRB).

4. The wireless device of claim 1, wherein
a first group of N SRS resources are configured in one SRS resource set used for periodic or semi-persistent SRS transmission.

5. The wireless device of claim 1, wherein
a second group of N SRS resources are configured in more than one SRS resource sets used for aperiodic SRS transmission.

6. The wireless device of claim 5, wherein
the N SRS resources are configured, with any combination, in said more than one SRS resource sets used for aperiodic SRS transmission; or
the N SRS resources are configured evenly in said more than one SRS resource sets used for aperiodic SRS transmission.

7. The wireless device of claim 5, wherein for said more than one SRS resource sets, one or more of the following is configured:
said more than one SRS resource sets are associated with a same Non-Zero Power (NZP) Channel State Information Reference Signal (CSI-RS) Resource;
said more than one SRS resource sets are configured with same power control parameters; and
said more than one SRS resource sets are configured with a same SRS trigger state.

8. The wireless device of claim 5, wherein
the processor is further configured to receive from the cellular base station, via the at least one radio, Downlink Control Information (DCI) triggering aperiodic SRS transmission, and wherein
the processor is further configured not to update the SRS precoding information if a gap from the last symbol of the reception of the Non-Zero Power (NZP) Channel State Information Reference Signal (CSI-RS) Resource associated with the second group of N SRS resources and the first symbol of the aperiodic SRS transmission is less than M Orthogonal Frequency Division Multiplexing (OFDM) symbols, wherein M>42 and a time length of the M symbols is calculated based on the minimum one of a Sub-Carrier Spacing (SCS) of the NZP-CSI-RS and an SCS of the SRSs to be aperiodically transmitted.

9. The wireless device of claim 8, wherein
the processor is further configured to transmit, via the at least one radio, capability information to the cellular base station indicating the value of M, or
the value of M is defined as a fixed value in advance.

10. The wireless device of claim 5, wherein
the N SRS resources configured in said more than one SRS resource sets are ordered according to identifiers of the SRS resource sets.

11. The wireless device of claim 10, wherein, the processor is further configured to
receive from the cellular base station, via the at least one radio, Downlink Control Information (DCI) indicating at least one SRS resource from the N SRS resources by indicating at least one identifier based on the order corresponding to the at least one SRS resource, and
in response to the DCI, transmit, via the at least one radio, uplink data using precoding information corresponding to the at least one SRS resource.

12. The wireless device of-claim 1 or 2 claim 1, wherein for a scenario enabling communication between the wireless device and more than one Transmission and Reception Points (TRP) of the cellular base station:
for each TRP, a third group of up to N SRS resources for non-codebook is configured in at least one SRS resource set used for aperiodic SRS transmission, and
a total number of the SRS resources configured for all the TRPs of the cellular base station is no larger than N,
wherein, N represents a maximum number of layers supported by the wireless device for uplink transmission.

13. The wireless device of claim 12, wherein for the scenario enabling communication between the wireless device and more than one TRPs of the cellular base station:
SRS resource sets configured for a TRP are associated with a same SRS trigger state and SRS resource sets configured for different TRPs are associated with different SRS trigger states, and mapping between an SRS Resource Indicator (SRI)/Quasi-collocation (QCL)/Spatial relation and a specific SRS resource set is determined based on the SRS trigger state; or
SRS resource sets configured for different TRPs are associated with a same SRS trigger state, and mapping between an SRS Resource Indicator (SRI)/Quasi-collocation (QCL)/Spatial relation and a specific SRS resource set is determined based on a predetermined rule.

14. A cellular base station, comprising:
at least one antenna;
at least one radio coupled to the at least one antenna; and
a processor coupled to the at least one radio;
wherein the processor is configured to:
transmit, via the at least one radio, at least one Radio Resource Control (RRC) signaling to a wireless device, wherein, the at least one RRC signaling configures at least one group of N Sounding Reference Signal (SRS) resources for non-codebook, N>4, and each SRS resource is configured with one port; and
receive, via the at least one radio, SRSs from the wireless device on the configured group of SRS resources, wherein each SRS is received on one SRS resource of the configured group of SRS resources.

15. The cellular base station of claim 14, wherein
the processor is further configured to receive, via the at least one radio, capability information from the wireless device indicating whether the wireless device supports simultaneous transmission of multiple SRSs for non-codebook in a same symbol and/or a maximum number of supported simultaneously transmitted SRSs for non-codebook in one symbol; and
at least two SRS resources of the N SRS resources occupy a same symbol in the case where the wireless device supports simultaneous transmission of multiple SRSs for non-codebook in a same symbol.

16. The cellular base station of claim 14, wherein
at least two SRS resources of the N SRS resources occupy a same Physical Resource Block (PRB).

17. The cellular base station of claim 14, wherein
a first group of N SRS resources are configured in one SRS resource set used for periodic or semi-persistent SRS transmission.

18. The cellular base station of claim 14, wherein
a second group of N SRS resources are configured in more than one SRS resource sets used for aperiodic SRS transmission.

19. The cellular base station of claim 18, wherein
the N SRS resources are configured, with any combination, in said more than one SRS resource sets used for aperiodic SRS transmission; or
the N SRS resources are configured evenly in said more than one SRS resource sets used for aperiodic SRS transmission.

20. The cellular base station of claim 18, wherein for said more than one SRS resource sets, one or more of the following is configured:
said more than one SRS resource sets are associated with a same Non-Zero Power (NZP) Channel State Information Reference Signal (CSI-RS) Resource;
said more than one SRS resource sets are configured with same power control parameters; and
said more than one SRS resource sets are configured with a same SRS trigger state.

21-47. (canceled)
